(19) United States
(12) Patent Application Publication
(10) Pub. No.: US 2003/0141973 A1
(43) Pub. Date: Jul. 31, 2003

(54) Smart object locator

(76) Inventors: Hen-Geul Yeh, Cypress, CA (US); Hsien-Yang Yeh, Cypress, CA (US)

Correspondence Address: CHRISTIE, PARKER & HALE, LLP, P.O. BOX 7068, PASADENA, CA, 91109-7068, US

(21) Appl. No.: 10/337,244

(22) Filed: Jan. 6, 2003

Related U.S. Application Data
(63) Continuation-in-part of application No. 09/911,922, filed on Jul. 24, 2001, now Pat. No. 6,529,142.

(51) Int. Cl. G08B 1/08

(52) U.S. Cl. 340/539.13; 340/573.4; 342/147

(57) ABSTRACT

The presentation is a low-cost, two-way communication system and method for aid in locating an object, such as a container or a package and reporting the contents of the object to a site remote from the location of the object. In one embodiment, the system includes two modules. A remote module includes a directional antenna array mounted on the top of the module (i.e., in a remote site), a processor including a direction-finding software, and a display for pointing the direction of the container's location relative to the remote site.

Additionally, a response module includes a transceiver mounted on or within the container, which only allows an unique digital waveform to pass through and to response to a search signal from the remote module by transmitting a direction signal. This direction signal then activates the display in the remote module to indicate the location of the container relative to the remote module. In one embodiment, the response module accesses a database of the container and sends out the container's information to the remote module upon a request.

### CROSS REFERENCE TO RELATED APPLICATIONS

This application is a continuation-in-part of U.S. patent application Ser. No. 09/911,922, filed on Jul. 24, 2001 and entitled “PARKED VEHICLE LOCATION FINDER”, the entire contents of which are hereby expressly incorporated herein by reference.

### FIELD OF THE INVENTION

This invention relates generally to devices, systems methods that aid in locating an object, such as a cargo container.

### BACKGROUND OF THE INVENTION

Searching for objects, such as containers and large packages, whether in a large port, train station, airport, or in a warehouse, is a commonplace daily event. Searchers often may wonder around for some time until they spot the container or the package. This practice is usually time-consuming and at times can be frustrating. Even once the container is located, one usually has to look for and read a label or open the container to determine and/or verify the contents of the container. Labels may include long lists of contents and may not be accurate and up-to-date. With increasing concerns about security and the need to identify the contents of containers arriving from abroad, any questionable and suspicious container has to be identified, located and the contents verified in a timely manner.

Therefore, there is a need for a low-cost, two way communication system and method for aid in locating an object, such as a container, and reporting the contents of the object.

### SUMMARY OF THE INVENTION

The present invention provides a low-cost, two-way communication system and method for aid in locating an object, such as a container and/or a package and reporting the contents of the object to a site remote from the object. In one embodiment, the system includes two modules. First, a remote module includes a directional antenna array mounted on the top of the module (i.e., at a remote site), a processor including a direction-finding software, and a display. The remote module is mountable on or within a forklift, a crane, a truck, a handheld device, or the like for locating the object. In one embodiment, a display for indicating the direction of the container's location relative to the remote site is employed in the remote module. Additionally, a speaker may be included in the remote module to generate one or more sounds, such as a beeping sound, with different volume and/or different frequency to indicate the direction of the object's location relative to the remote site.

Second, a response module includes a receiver and a transmitter mounted on or within the object, which receives the search signal from the remote module and responses to the search signal by a response signal. This returned direction signal then activates the display or the speaker within the remote module to indicate the location of the object relative to the remote module. In one embodiment, the response module accesses a database of the object and sends out the object's information to the remote module upon a request. In one embodiment, the container's database is programmable via wireless and/or wired connections.

Advantages of the present invention include reducing human errors due to busy operation at a port or warehouse. Additionally, with an unique identification (ID) number, each container/package is transformed to a smart and active container/package for easy and accurate interaction with all involved operators in the port or warehouse. This also results in speeding up moving and enhancing the shipping time of the container/package from one location to another. Further, the present invention can be easily employed by the homeland security apparatus as a fast locator for any questionable container without loss of generality, the container and object are interchangeable in the following paragraphs.

In one aspect, the present invention is a two-way communication system for locating an object, comprising: an antenna array located at a remote site relative to location of the object capable of transmitting a search signal and receiving a direction signal; a first processor located at the remote site electrically coupled to the antenna array, the first processor including a direction-finding software; a display monitor located at the remote site electrically coupled to the first processor for displaying information including information about location of the object; a transceiver at the object location for receiving the search signal and transmitting the direction signal; and a second processor located at the object location capable of receiving the search signal and transmitting the direction signal to the first processor at the remote site, wherein the first processor determines the location of the object from the received direction signal using the direction-finding software to estimate the angle of arrival (AOA) and displays the information about the location of the object on the display monitor.

In another aspect, the present invention is a smart container comprising: an antenna for transmitting and receiving signals; a receiver for receiving a request signal; a transmitter for transmitting an information signal; a memory for storing a database including information about the contents of the container; and a processor electrically coupled to the memory for accessing the database and encoding information about the contents of the container stored in the database in the information signal for transmission to a remote site, responsive to the received request signal.

In yet another aspect, the present invention is a two-way communication system for displaying contents and shipping information of a container comprising: a first processor at a remote site for transmitting a request signal and receiving an information signal; a display monitor at the remote site and electrically coupled to the first processor for displaying information, including information about the contents of the container; a transceiver at the container location for receiving the request signal and transmitting the information signal; a memory at the container location for storing a database including the information about the contents of the container; and a second processor at the object location and electrically coupled to the memory for receiving the request signal, accessing the database, sending the information about the contents of the container in the information signal to the first processor, responsive to the received request signal, wherein the first processor displays the information about the contents of the container on the display monitor, responsive to the received information signal.

### BRIEF DESCRIPTION OF THE DRAWINGS

These and other features, aspects, and advantages of the present invention will be more fully understood when considered with respect to the following detailed description, appended claims and accompanying drawings, wherein:

FIG. 1 shows an exemplary functional block diagram of a smart container communication system, according to one embodiment of the present invention;

FIG. 2 is an exemplary representation of a two-dimensional, multiple element array antenna that is part of a remote module, according to one embodiment of the present invention;

FIG. 3 is a test-computed plot of the vertical antenna array response to the incoming signal wave front indicated in FIG. 2, particularly showing a peak that indicates the estimated signal angle of arrival (AOA);

FIG. 4 is an exemplary test plot of the tilt-horizontal antenna array response to the test incoming signal wave front, particularly showing a peak that indicates the estimated signal angle of arrival (AOA); and

FIG. 5 is an exemplary table of signal-to-noise (SNR) ratio at baseband vs. variance of the AOA estimator.

### DETAILED DESCRIPTION

In one embodiment, the present invention describes a system and method for locating an object, such as a container and/or a package in a port, station, warehouse, or the like. The system comprises two modules: a response module and a remote module. When activated, the modules communicate with each other by means of specially encoded radio signals.

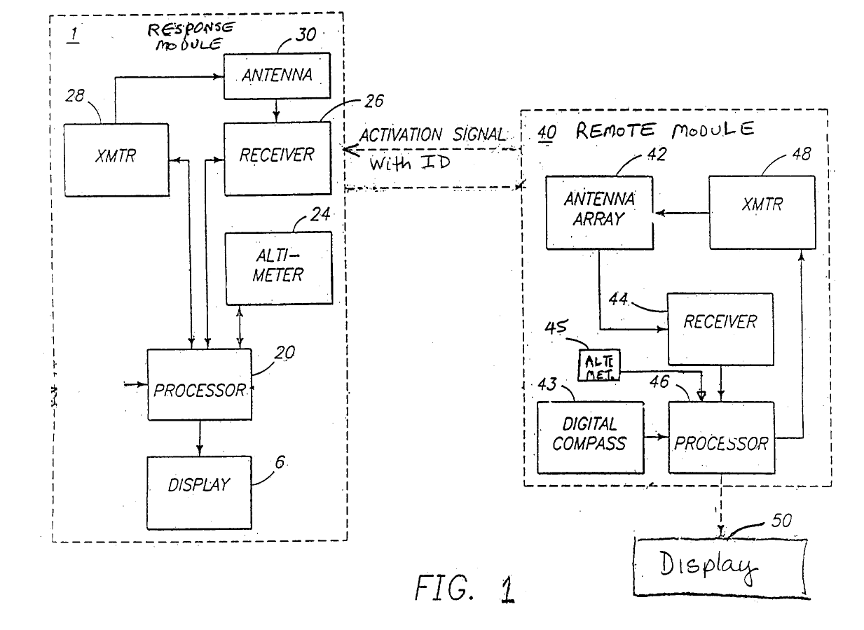

FIG. 1 shows an exemplary functional block diagram of a smart container communication system, according to one embodiment of the present invention. The system shown in FIG. 1 is a two-way communication system that includes a response module 1 at the object site and a remote module 40 at a site remote relative to the location of the object. The response module 1 includes an antenna 30, a transmitter 28, a receiver 26, an altimeter 24, a microprocessor 20, a display light 6, and an Input/Output (I/O) port 34. The I/O port 34 may be a wireless connection port and/or a wire connection. A memory 32 stores the container's ID and goods information. The I/O port 34 is designed for updating the container's information by an external computer. Additionally, the container's information may be updated by the remote module.

The remote module 40 includes an antenna array 42, a transmitter 48, a receiver 44, a processor 46, a digital compass 43, an altimeter 45, and a display 50, as shown in FIG. 1. The location of the container and the goods information are showed on the display 50.

In one embodiment, the antenna array 42 is a directional antenna array mounted on the remote module, and processor 46 includes a direction-finding software. The remote module is mountable on or within a forklift, a crane, a truck, a handheld device, or the like for locating the container. Display 50 indicates the direction of the container's location relative to the remote site.

In one embodiment, the directional antenna includes a digital signal processor (DSP) based two-dimensional eight-element adaptive antenna array for wireless object locating, as described below. A user activates a locator button on the remote module and selects an identifier for a desired container/package. A search signal, requesting information from the response module is then generated by the processor 46 and transmitted by the transmitter 48 via the antenna array 42 to the response module 1.

The receiver 26 in the response module receives the signal via the antenna 30 and sends the search signal to the processor 20 in the response module. The processor 20 checks the unique identifier (or a waveform) to determine whether the search signal is intended for that response module. If the unique identifier does not match the container's unique code, then the response module doe not respond. However, if the unique identifier matches the container's unique code, processor 20 generates a direction signal and transmitter 28 sends the direction signal back to the remote module via antenna 30. Receiver 44 receives the direction signal via antenna array 42 and sends the received signal to the processor 46 at the remote module 40 to be processed.

Processor 46 computes an antenna pattern from the direction signal by using two independent adaptive algorithms described below. Processor 46 first determines the entry angle of the direction signal relative to the remote module using a direction-finding software and digital compass 43, and then activates proper direction light(s) on the display 50.

In one embodiment, display 50 includes ten direction arrow lights (for example, LED lights) for indicating eight different directions (e.g., North, North-West, West, South-West, South, South-East, East, and North-East), Up, and Down. When a direction signal is received from the response module, one of the display direction arrows lights up in the direction of the container/package. If the container is located at a higher or lower elevation with respect to the remote module, one of the two display elevation arrows lights up, pointing up or down. Also, display light 6 at the container location lights up, indicating the location of the container. The user then approaches the container/package in the direction of the lit arrows on display 50. If the user passes the container/package, the arrows redirect the user by switching directions. A speaker may also be included in the remote module to generate one or more sounds, such as beeping sound, with different volume and/or different frequency to indicate the direction of the container's location relative to the remote site.

In one embodiment, when an information request button on the remote module is activated, a request signal is generated and transmitted from the remote module 40 to the response module 1. The receiver in the response module receives the request signal and the request signal causes processor 20 to access the container's database. Processor 20 in the response module accesses the database from memory 32 to retrieve information about the container stored in the database. The container's information stored in the database includes one or more of type, weights, size, and volume of goods, and shipping instructions related to the container. This information is then transmitted back to the remote module and is then displayed on display 50. The container's database may be updated via a wireless connection or via a computer with wire connection to the response module.

In one embodiment, the search and the request signal are different signals of ultra high frequency (UHF) or higher frequency covering the area where the container/package is located.

In one embodiment, processor 20 is programed to generate and initiate an encoded direction signal transmission upon demand; to activate and read altimeter 24; to process incoming search digital signals received by the receiver 26; and to send the resulting direction signals to the transmitter 28 to be transmitted to the remote module to illuminate the direction indicators on the display 50.

In one embodiment, remote module 40 circuitry is typically powered by a battery found on the forklift or the crane, on which the remote module is installed. Alternatively, remote module 40 may contain its own battery or other (optionally re-chargeable) power sources. The response module 1 may also contain its own battery or other power source.

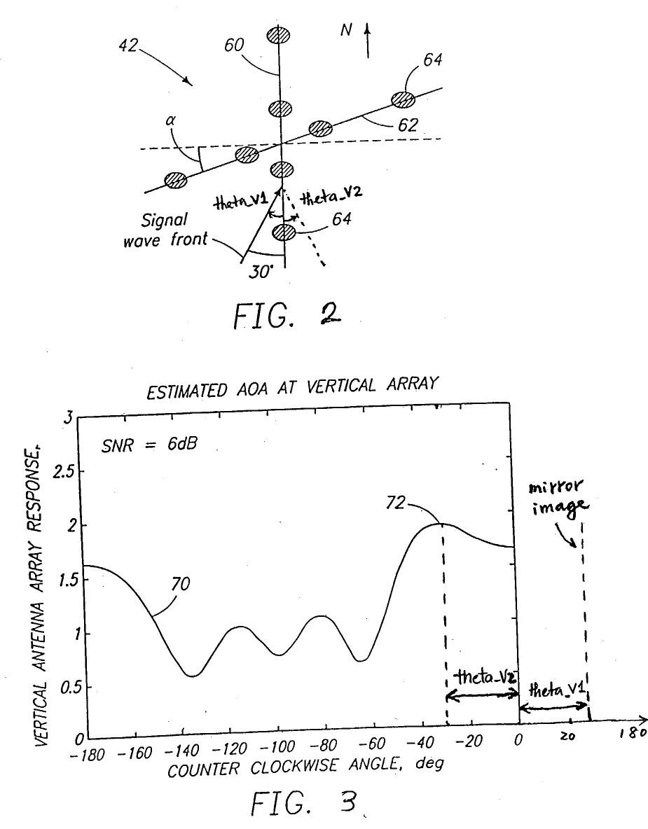

FIG. 2 is an exemplary representation of a two-dimensional multiple element array antenna that is part of the remote module, according to one embodiment of the present invention. In FIG. 2, vertical and tilt-horizontal antenna arrays and the angle of a test simulation incoming signal wave front that was emitted by the response module are shown. The adaptive antenna array 42 comprises two independent linear arrays 60, 62, each independent array having multiple elements 64. The array geometry is a two-dimensional cross shape, with one linear array 60 designated as “vertical” and the other linear array 62 designated as “horizontal”. For optimum operation, the horizontal array 62 is tilted alpha degrees counterclockwise around the center of the vertical array, as shown in FIG. 2. The value of alpha is typically about 30 degrees, but may be varied somewhat to suit a particular placement in a remote module.

The “N” (North) arrow reference shown in FIG. 2 is only a reference for the vertical array direction, which may be actually pointed in any compass direction. When in use, the north direction with respect to the vertical array is determined by the digital compass 43 in the remote module 40.

An exemplary adaptive antenna array is depicted in FIG. 3. In one embodiment, the antenna is particularly designed for wireless object locator. Also, a choice of an ultra high frequency (UHF) or higher frequency signal transmission results in a very small size planar antenna array. The antenna array can then be easily packaged in a small, thin module together with a circuit board, and mounted unobtrusively as the remote module.

In one embodiment, processor 46 is a digital signal processor (DSP) which, generates a request signal for transmission to response module is programed to process a received direction signal, to determine the entry angle of the direction signal at the antenna array 42 relative to true north. Two independent processes are used by the processor 46 to compute the received antenna signal patterns and determine the signal entry angle of arrival (AOA). These processes are part of the program for the DSP.

The combined processes steps are summarized as follows:

1. Calculate an estimated AOA (angle of arrival) with respect to the vertical antenna axis, theta_V2, and its mirror image, theta_V1, as shown in FIG. 3.

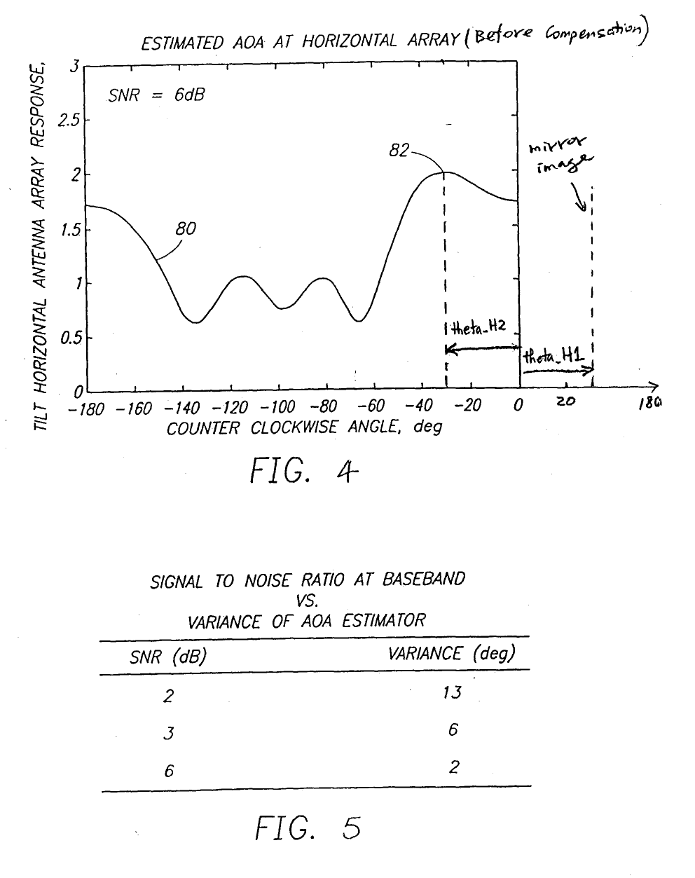

2. Calculate the estimated AOA with respect to the horizontal antenna axis, theta_H2, and its mirror image, theta_H1, as shown in FIG. 4.

3. Compensate the estimated AOA for the tilt orientation of the horizontal antenna axis.

4. Select a pair which is the minimum of abs(theta_H1-theta_V1), abs (theta_H1-theta_V2), abs (theta_H2-theta_V1), abs (theta_H2-theta_V2)for four different pair combinations of theta H1,H2,V1,V2, and calculating the average value of the selected pair as the estimated AOA with respect to the antenna array.

In one embodiment, the operation of the smart object locator system is described as follows:

A. A user at the remote module 40 initiates a search signal to processor 46, which generates a specially encoded signal for transmitter 48. Transmitter 48 then produces a high frequency signal for transmission by the omni-directional antenna array 42 to the general area where the object is located.

B. After the container/package received and accepted the search signal in a port or warehouse, the container's altitude is automatically measured by altimeter 24 in response module 40 and the altitude is recorded in memory 32 for future reference. This altitude is transmitted to the remote module with the direction signal.

C. The adaptive antenna array on the remote module 40 receives the direction signal and passes the signal to receiver 44. Receiver 44 translates the received signal to a digital signal and outputs the digital signal to processor 46. Processor 46 computes the AOA (angle of arrival of the incoming signal) with respect to the antenna array, using two independent algorithms, one for each of the two antenna linear arrays. Processor 46 then compensates the antenna results for true north using inputs from digital compass 43 to produce an estimated AOA. Processor 46 also reads the remote module's altitude from its altimeter, and compares it with the altitude of the response module.

D. Processor 46 then computes whether the container is located on a higher or lower plane relative to the remote module, from the received altitude data.

E. Processor 46 passes the calculated results to display 50 to activate the direction and elevation arrows.

The above events described in steps A through E take place substantially in real time. As the orientation of the remote module with respect to the container is changed, the direction arrows displayed on display 50 change.

A simulated test of the vehicle remote module 40 was performed to verify the performance of the system. The adaptive antenna 42 was configured and set up on a two-dimensional x-y plane as shown in FIG. 2, with the vertical linear antenna pointing to true north. A simulated wave front emitted by the response module was postulated as arriving at the antenna 42 at an input angle of 30 degrees clockwise from south, equivalent to an angle of −30 degrees counterclockwise from south.

The response of the vertical antenna array and the tilt-horizontal array to the input simulated wave front was then computed, based on an SNR (signal-to-noise ratio) of 6 dB at the receiver baseband.

FIG. 3 is an exemplary plot of the computed resulting antenna signal pattern magnitude at the vertical antenna array over the counterclockwise angles of 0 to −180 degrees. The estimated AOA, theta_V2, corresponds to the peak value 72 of the array response, that is, theta_V2=−30 degrees.

A computation was then made to determine the mirror image of theta_V2, taken over the clockwise range of 0 to 180 degrees, which resulted as theta_V1=30 degrees.

The foregoing set of computations was also performed for the signals received by the tilt-horizontal array. FIG. 4 shows an exemplary plot of the computed resulting signal pattern at the tilt-horizontal antenna array over the counterclockwise angles of 0 to −180 degrees. The estimated AOA, theta_H2, corresponds to the peak value 82 of the array response, that is, theta_H2 −29 degrees. Its mirror image is theta_H1=+29 degrees.

After compensating for the tilt angle orientation of the horizontal array, theta_H2 was recalculated as being 31 degrees and theta_H1=89 degrees.

Using the above calculated values for theta_V1,V2,H1 and H2, the computed results of the applied algorithm resulted in a final estimated AOA with respect to the vertical array (true North)=30.5 degrees. At this point, the remote module would display the location of the object by indicating an AOA of 30.5 degrees, which is quite accurate.

In one embodiment, the processes used by the processor 46 to compute the received antenna signal patterns and determine the signal entry angle of arrival (AOA) include:

A. In the remote module, a digital down converter generates baseband in-phase and quadrature signal components from each antenna element. Processor 46 receives vertical antenna 4-element digital complex inputs s0, s1, s2, s3, and digital compass input of the antenna orientation with respect to true north.

B. Processor 46 computes the error and complex weights of the signals, using adaptive algorithm iteratively (such as least mean square (LMS) algorithm):

err=s0−s1*conj(h1)−s2*conj(h2)−s3*conj(h3)

hi=hi+2*mu*conj(err)*si, i=1,2,3

Where, the steady state weights of h1, h2, and h3 are h1ss, h2ss, h3ss, respectively.

C. Processor 46 computes steering vector to form antenna pattern with respect to the vertical axis lamda=radio wave length generated by the response transmitter l=0.5*lamda, (the spacing between antenna element is lamda/2).

AOA search range from −180° to 0° with small increment (for example, one °)

th_test=−180:1:0

d=l*cos(th_test*pi/180)

delta=2*pi*d/lamda

where, Steering vectors

a0=1

a1=exp(j*delta)

a2=exp(j*2*delta)

a3=exp(j*3*delta)

Where, antenna pattern

y=a0+h1ss*conj(a1)+h2ss*conj(a2)+h3ss*conj(a3)

mag_{—}y=abs(y)

D. The estimated AOA relative to the vertical array=theta_V2 (negative, counter clockwise from south) is obtained by finding the angle corresponding to the peak value of antenna pattern as shown in FIG. 3. However, its image, theta_V1=−theta_V2, is another possible AOA. To solve the ambiguity of the estimated AOA with respect to antenna arrays, processor 46 receives horizon antenna 4-element digital complex inputs, and repeats similar computations as the vertical array independently to find the estimated AOA. The horizontal array is tilted by 300 counter clockwise.

E. The estimated AOA relative to the horizontal axis=theta_H2 (negative, counter clockwise) is obtained by finding the angle corresponding to the peak value of antenna pattern as shown in FIG. 4. The image of the estimated AOA relative to horizontal axis is an another possible AOA.

theta_{—}H1=−theta_{—}H2

F. Compensate the tilt orientation

theta_{—}H1=theta_{—}H1+60°.

theta_{—}H2=theta_{—}H2+60°.

G. Choose the pair which is the minimum of abs(theta_H1-theta_V1), abs(theta_H1-theta_V2), abs(theta_H2-theta_V1), and abs(theta_H2-theta_V2). The averaged value of the selected pair is the final estimated AOA with respect to the vertical antenna array.

H. The AOA of the received signal with respect to true north is equal to the estimated AOA with respect to the vertical antenna array compensated by the digital compass measurement of antenna orientation with respect to true north.

FIG. 5 is an exemplary table of the probable maximum variance of the AOA estimator for given levels of SNR at the receiver baseband. It is suggested that the SNR at the receiver baseband should be greater than 3 dB to obtain a reliable estimated AOA.

In one embodiment, the power level for signal transmission between the remote and response modules is estimated at around 0.25 watt. This should be adequate for a search and receive radius of a quarter mile, as encounter for example, when searching a warehouse. In one embodiment, all the electrical components in the system modules, excepting the antennas, are standard available parts. These components are small in size, and can all be connected on a circuit board at a relatively low cost for packaging in a module. Since the signal frequency is high, the antennas are also small in size, so that both system modules are small in size and slim in thickness. The small size of the remote module allows the module to be placed conveniently inside a vehicle instead of being attached to the outside of the vehicle.

Another advantage of the system is that both remote and response modules may include their own (optionally rechargeable) battery power source and thus can be portable and moved from one object vehicle pair to another as needed. Alternatively, the remote module may be placed at a fixed location, such as an office in a port or warehouse.

In one embodiment, the altimeter and digital compass in the remote module and the altimeter in the response module may be removed for a low-cost version of the system. The antenna array may also be changed to a single antenna for a low-cost version.

It will be recognized by those skilled in the art that various modifications may be made to the above-described and illustrated embodiments of the invention without departing from the broad inventive scope thereof. It will be understood therefore that the invention is not limited to the particular embodiments or arrangements disclosed but, rather is intended to cover any changes, adaptations or modifications which are within the scope and spirit of the invention as defined by the appended claims. For example, although the terms “container” and “package” are mostly used in the description, those skilled in the art will easily recognize that the scope of the present invention includes objects similar to a container or a package. Additionally, the number of elements used in antenna arrays may be increased or decreased with different geometry, the number of antenna arrays may also be increased or decreased.

What is claimed is:

1. A two-way communication system for locating an object comprising:
an antenna array located at a remote site relative to the object and capable of transmitting a search signal and receiving a direction signal;
a first processor at the remote site electrically coupled to the antenna array, the first processor including a direction-finding software;
a display monitor at the remote site electrically coupled to the first processor and capable of displaying information including information about location of the object;
a transceiver at the object location for receiving the search signal and transmitting the direction signal; and
a second processor at the object location and capable of receiving the search signal, and encoding the measured altitude upon request in the direction signal for transmission to the first processor at the remote site,
wherein the first processor determines the location of the object from the received direction signal using the direction-finding software and displays the information about the location of the object on the display monitor.

2. The system of claim 1, wherein the object is a cargo container.

3. The system of claim 2, further comprising a memory at the container location and electrically coupled to the second processor for storing a database including information about the contents of the container.

4. The system of claim 3, wherein the first processor at the remote site transmits an information request signal to the second processor at the container location, and the second processor accesses the database and sends the information about the contents of the container to the first processor, responsive to the received information request signal.

5. The system of claim 3, further comprising an external connection to the memory for updating the database by an external device.

6. The system of claim 5, wherein the connection is a wireless connection.

7. The system of claim 5, wherein the connection is a wired connection.

8. The system of claim 3, wherein the information about content of the container includes one or more of the group of weights of contents, sizes of contents, volumes of contents, and shipping information related to the contents.

9. The system of claim 3, wherein the transceiver, the memory and the second processor are mounted in a module on the container.

10. The system of claim 1, wherein the direction-finding software comprises:
means for calculating an estimated AOA with respect to a vertical antenna axis, theta_V2, and its image, theta_V1;
means for calculating the estimated AOA with respect to a horizontal antenna axis, theta_H2, and its image, theta_H1;
means for compensating the estimated AOA for tilt orientation of the horizontal antenna axis; and
means for selecting a pair as the minimum of abs (theta_H1-theta_V1), abs (theta_H1-theta_V2), abs (theta_H2-theta_V1), and abs (theta_H2-theta_V2) for four different pair combinations of theta H1,H2,V1,V2, and calculating the average value of the selected pair as the estimated AOA with respect to the antenna array.

11. The system of claim 1, wherein the search signal and the direction signal are different signals of UHF or higher frequency.

12. The system of claim 1, further comprising
a first altimeter at the object location capable of recording the altitude of the object;
a second altimeter at the remote site capable of recording the altitude of the remote site; and
a digital compass at the remote site capable of determining the orientation of the antenna array relative to the true north.

13. A smart container comprising:
an antenna capable of transmitting and receiving signals;
a receiver capable of receiving a request signal;
a transmitter capable of transmitting an information signal;
a memory for storing a database including information about the contents of the container; and
a processor electrically coupled to the memory and capable of accessing the database and encoding information about the contents of the container stored in the database in the information signal for transmission to a remote site, responsive to the received request signal.

14. The container of claim 13, further comprising an external connection to the memory for updating the database by an external device.

15. The container of claim 14, wherein the connection is a wireless connection.

16. The container of claim 14, wherein the connection is a wired connection.

17. The container of claim 13, wherein the information about the contents of the container includes one or more of the group weights of contents, sizes of contents, volume of contents, and shipping information related to the contents.

18. The container of claim 13, further comprising an altimeter for recording the altitude of the container.

19. The container of claim 13, wherein the processor receives a search signal from a remote site, and encodes the measured altitude in a direction signal for transmission to the remote site.

20. A two-way communication system for displaying the contents of a container, comprising:
a first processor located at a remote site relative to the container and capable of transmitting a request signal and receiving an information signal;
a display monitor located at the remote site and electrically coupled to the first processor capable of displaying information including information about the contents of the container;
a transceiver at the container location and capable of receiving the request signal and transmitting the information signal;
a memory at the container location for storing a database including the information about the contents of the container; and
a second processor at the object location and electrically coupled to the memory and capable of receiving the request signal, accessing the database, sending the information about the contents of the container in the information signal to the first processor, responsive to the received request signal, wherein the first processor displays the information about the contents of the container on the display monitor, responsive to the received information signal.
